(19) United States
(12) Patent Application Publication
(10) Pub. No.: US 2004/0262022 A1
(43) Pub. Date: Dec. 30, 2004

(54) Alloy compositions for electrical conduction and sag mitigation

(76) Inventor: Manuchehr Shirmohamadi, Castro Valley, CA (US)

Correspondence Address: MANUCHEHR SHIRMOHAMADI, 18637 WEST CAVENDISH DRIVE, CASTRO VALLEY, CA, 94552, US

(21) Appl. No.: 10/891,325

(22) Filed: Jul. 14, 2004

Related U.S. Application Data
(63) Continuation-in-part of application No. 10/649,174, filed on Aug. 26, 2003.
(60) Provisional application No. 60/407,060, filed on Sep. 3, 2002.

(51) Int. Cl. H02G 7/00

(52) U.S. Cl. 174/40 R

(57) ABSTRACT

Shape memory alloys for use in devices for mitigation of sag in a suspended line, the alloys comprising at least Iron, Manganese and Silicon. Additionally, Chromium, Nickel, Cobalt, Niobium, Copper, Aluminum, Nitrogen, Boron and Carbon may be included. The Iron content of the alloys is generally between about 60 and 70% wt. The manganese content is generally between about 16 and 30% wt. The Silicon content is generally between about 4 and 8% wt, most commonly about 6% wt. Chromium may be present at about 9% wt. Nickel may be present at about 5% wt. Cobalt may be present at about 10% wt. Niobium may be present at about 1% wt. Nitrogen and Boron may be present at about 0.2% wt. Carbon may be present at about 0.5% wt.

This patent application is a continuation-in-part of and claims the benefit of currently pending U.S. application Ser. No. 10/649,174 filed Aug. 26, 2003, which itself claims benefit of provisional application No. 60/407,060 filed Sep. 03, 2002.

### FIELD OF THE INVENTION

This invention relates to ferrous shape memory alloys used in devices that can automatically compensate for changes in transmission line sag.

### BACKGROUND

Devices for mitigating sag in a suspended line, for example a power line, have been disclosed in previous patents and applications to Manuchehr Shirmohamadi: U.S. Pat. No. 6,057,508 and U.S. Pat. No. 5,792,983 and PCT US9917819, WO0008275. These above-mentioned patents and application are incorporated by reference in their entirety.

Transmission power lines are electrical lines that typically carry high voltage, e.g., 230 KV. For reasons of safety, such lines are suspended well above ground level, typically from towers or the like. The power lines are suspended from towers with insulating devices for example ceramic or glass and rubber and fiberglass insulators whose length can range from a few inches, such as six inches, to over fifteen feet depending on the voltage in the line and the environment.

Power lines intrinsically tend to sag. This initial sag increases with line temperature because the conducting material of which the line is made expands as line temperature increases, effectively lengthening the line. A small increase in line length produces a large, and potentially hazardous increase in sag. For example, for a line with a 500 foot tower spacing (a typical span for overhead transmission lines) and an aluminum conductor steel reinforced (ACSR) conductor (for example a drake conductor), a temperature increase of about 120° F. (from 100° F. to 212° F.—which can represent the expected conductor temperature change between winter and summer months) will causes about 6.4 inches increase in line length, which will increase the sag by about 4.7 feet.

Increase in line temperature may be due to a number of factors including increased ambient air temperature, decreased wind flow over the line and increased current flow through the line. Sagging power lines create fire hazards and other public safety issues due to ground clearance. The cost of line sag in terms of energy not sold and also tree trimming and litigation expenses are very well known to the electricity generation and transmission industry. Sagging power lines pose an electrocution hazard to persons and vehicles and can lead to interruption in power supply and are known to cause hugely destructive and expensive forest and brush fires.

The same problem of sag also affects all other suspended structures such as bridges, suspended telecommunications wires and structural cables. Such wires and cables include cables used in construction of buildings and bridges. Additionally the same problem may affect any wire that is under tension, such as guide wires and cables used for transmitting force from a control to an instrument such as may be used in boats and aircraft and cars and other machines to, for example, control a rudder or aerolon or braking system.

Present techniques to compensate for such sag caused by undesired increase in length of a cable include: (i) Shortening the distance between adjacent towers to reduce span length and thus reduce line sag; (ii) Erecting taller transmission towers to accommodate line sag. (iii) Replacing existing conductors with new ones with higher ampacity or lower sag characteristics. (iv) Retro-fitting existing towers to increase height. (v) Limiting electrical current load capacity to compensate for increased ambient temperature. (vi) Other methods for reducing sag and for keeping a suspended line taught include the use of constant tension elements such as springs and pre-stressed tensioners and even the use of strategically placed weights on the suspended line.

Other methods for combating sag have been disclosed in previous patents and applications to Manuchehr Shirmohamadi: U.S. Pat. No. 6,057,508 and U.S. Pat. No. 5,792, 983 and PCT US9917819, WO0008275, all of which are hereby incorporated by reference.

There is a need for a device that can be used to re-rate transmission power lines to carry greater amounts of electricity, which can automatically compensate for changes in conductor temperature to reduce thermal sag in the associated power lines. Preferably such devices should be inexpensive to fabricate, inexpensive to install, and substantially maintenance free. The present invention discloses such a device, and a method for reducing sag caused by temperature increase in suspended electrical transmission wires. The present invention also includes novel shape memory alloys used in sag-mitigation devices.

### BRIEF DESCRIPTION OF THE INVENTION

Two broad embodiments are disclosed: the “Sagging Line Mitigator” (SLiM) (FIG. 2) and the “SmartConductor” (FIG. 3).” These automatically compensate for sag in a suspended or hanging line, such as a power line. Both use a material that changes its dimensions as a function of temperature. One such material is shape memory alloy (SMA) which undergoes a phase transformation upon temperature change (referred to as transition) and produces a significant change in size and geometry. In this invention, both SLiM and SmartConductor use an SMA to conduct all, some or none of the total current in the power line. The SMA is heated by resistive heating (power loss=resistance×current\hat{ }2) of the SMA or by conduction from the conductor which itself is undergoing temperature increase due to resistive heating caused by current or by a combination of both methods. As the temperature of the SMA changes, it goes through the transition and will change shape accordingly. In this invention, the SMA will contract as its temperature increases. The contraction of the SMA produces a pulling force (increasing tensile force) which is directly (for SmartConducor) or indirectly (for SLiM) transferred to the suspended line, effectively pulling in the slack and reducing sag. SLiM uses at least one lever to amplify the SMA length change and transfer it to the suspended line. The SmartConductor does not use any lever and the length change of the SMA is applied to the suspended line directly, without any magnification.

Both devices are installed in-line using techniques similar to those used for installation of a “splice” or a “dead-end” on such lines. The “splice” technique is achieved by cutting the line at two positions at a given distance from each other and installing the device by connecting the device ends to the cut ends of the line. In case of a “dead-end” technique, installation is achieved by cutting the power line at one location at a given distance from its end connecting point to a fixed structure, such as a tower, and installing the device between the cut location of the line and the fixed structure and connecting the ends of the device to the cut end of the line and the fixed structure. Also, multiple devices can be installed in series if needed by cutting longer pieces of the power line.

The invention may take many different embodiments, some of which are set out below, depending on the arrangement of structural elements. But each embodiment does the same thing, mitigates line sag, in essentially the same way, by reducing the effective length of a power line through a direct or mechanically amplified change in the length of a SMA or other materials which will undergo dimensional change with temperature change.

The objects and advantages of the invention include, but are not limited to:

(i) provision of a means of mitigating power line sag which is considerably less expensive than current means;

(ii) provision of a means of mitigating power line sag which is automatic and self-adjusting such that the same change in ambient conditions (temperature, wind speed and direction, and solar radiation) that causes the line to sag will concomitantly cause the invention to act to mitigate the line sag;

(iii) provision of a means of mitigating power line sag which is automatic and self-adjusting such that the same change in line current (ampacity) that causes the line to sag will concomitantly cause the invention to act to mitigate the line sag;

(iv) provision of a means of mitigating power line sag without the necessity of replacing the power line with a new one with higher current capacity or lower sag characteristics;

(v) provision of a means of mitigating power line sag without the necessity of doubling or tripling (bundling) the power line with more conductors;

(vi) provision of a means of mitigating power line sag without the necessity of retrofitting transmission towers to make them taller;

(vii) provision of a means of mitigating power line sag which will allow transmission towers to be spaced at greater intervals than is presently necessary, thereby necessitating the erecting of fewer transmission towers;

(viii) provision of a means of mitigating power line sag which will allow the building of shorter transmission towers than is presently necessary;

(ix) provision of a means of mitigating power line sag without reducing line current (ampacity);

(x) provision of a means of mitigating power line sag which is inexpensive to manufacture and is essentially maintenance-free.

New Shape Memory Alloys

Transmission lines are designed to operate at various maximum temperatures depending on their materials (material limits) and construction methods (sag limits). For example, ACSR (Aluminum Conductor Steel Reinforced) conductors, where line tension is shared between the steel core and the aluminum cover, have a temperature limit of about 100° C. for its material, above which the aluminum part of the conductor anneals and looses its tension carrying capacity. Another class of conductors, such as ACSS (Aluminum Conductor Steel Supported), where all tension is carried by the steel core, has a much higher material temperature limit (about 250° C.). In either cases, the same conductor may have an operating temperature limits below its material temperature limit due to its sag consideration and construction. Finally, The final temperature limit on the line (material or sag consideration) can dictate the ampacity of the line.

Based on the operating temperature limits, therefore, the shape memory alloy core of the SLiM device or the SmartConductor, which is replacing part or all of an existing conductor or is used in new line construction, to increase line ampacity, will experience various operating regimes. Therefore, the core alloy selection for the SmartConductor considers such operating regimes. The alloys of the invention may be employed in any of the various sag-mitigation devices previously described that use shape-memory alloys. The alloys are designed to reduce or nullify line sag in a suspended conductor when heated due to line current and ambient conditions. In previous inventions mentioned above, the use of binary shape memory alloys (such as nickel-titanium) was presented. This invention encompasses alloys used as the core of the conductor. This invention relates to a new conductor with its core made of a new type shape memory alloy. The alloy disclosed is a low cost ferrous shape memory alloy to be used as the core of new conductors. The core is heated by thermal conduction from the aluminum conductor which itself is heated by current and ambient conditions and is thereby reduced in length. The alloy compositions of the invention include the following. The numbers before the elements represent percent weight (% wt).

Alloy 1:64Fe-16Mn-6Si-9Cr-5Ni

Alloy 2:64Fe-30Mn-6Si

Alloy 3:63.8Fe-16Mn-6Si-9Cr-5Ni-0.2N

Alloy 4:63.5Fe-30Mn-6Si-0.5C

Alloy 5: 59Fe-11Mn-6Si-9Cr-5Ni-10Co (Co to improve the corrosion resistance)

Alloy 6: 62.9Fe-16Mn-6Si-9Cr-5Ni-1Nb-0.2C (Nb is to form NbC for strengthening the material)

### BRIEF DESCRIPTION OF THE DRAWINGS

FIG. 1 shows a schematic of a overhead transmission line (30 and 30′) connected between two towers (10 and 20) via insulator strings (40) at two different conductor temperatures (T₀ and T₁) depicting line sag.

FIG. 2 shows a schematic diagram of a sag mitigating device (Sagging Line Mitigator, “SLiM”) in which the alloys of the invention may be employed.

FIG. 3 shows a schematic diagram of a second sag mitigating device (“SmartConductor”) in which the alloys of the invention may be employed.

FIG. 4 is a flow chart showing one example of a process by which the alloys of the invention may be processed.

FIG. 5 is a graph showing a temperature-deformation curve for a shape memory alloy at 25-40 ksi (kilo pounds per square inch) stress for the full transformation option. In this case the operational temperatures (90-250° C.) span the entire transformation regime.

FIG. 6 is a graph showing a temperature-deformation curve for a shape memory alloy at 25-40 ksi stress for the partial transformation option. The operational temperatures (90-250° C.) span only a portion of the transformation regime.

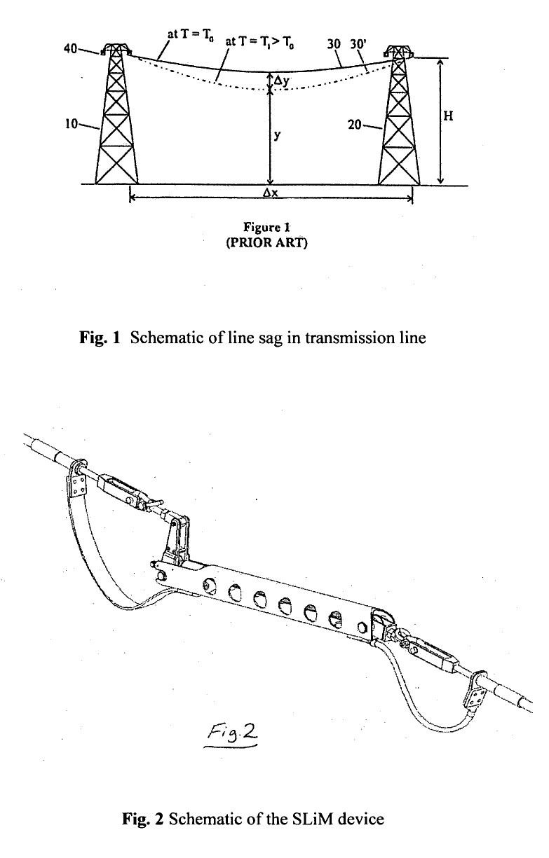

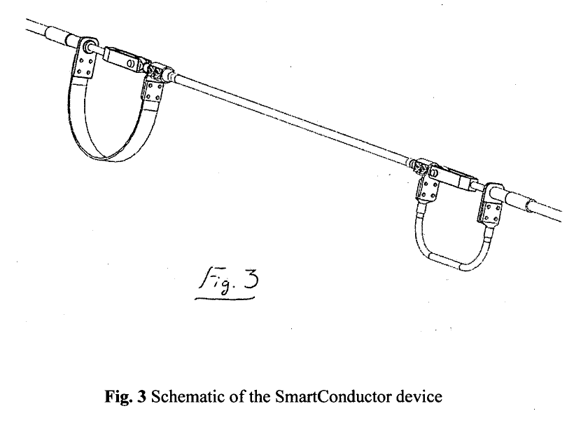

### DETAILED DESCRIPTION OF THE INVENTION

Sagging Line Mitigator (SLiM)

The material component that affects the change in length is referred to as an “actuator.” The actuator is a Shape Memory Alloy (SMA) that shortens or extends as its temperature increases depending on how the alloy is processed and/or trained. The shortening in length of the actuator produces a pull that is amplified and transferred to the transmission line using a single lever system. The actuator is activated by the same temperature changes that cause a conductor to sag. As temperature increases, the SMA contracts and the SLiM device changes its geometry to apply a pull on the line thereby decreasing line length. As conductor temperature returns to normal, SLiM returns to its original geometry. The actuator element forms part of the conductor, so that a part or all of the total current is conducted through the actuator when in use. The rest of the current is conducted through another element of the device such as the body, which may be formed of one or more hollow tubes. In certain embodiments, the SMA is surrounded by the hollow tube (pipe) body. The body in one embodiment acts both as a structural element for the lever action and as a housing to reduce the corona emitted by the device. A SMA has a start transition temperature and a stop transition temperature at which the physical change (transition) begins and ends. The amount of current required must be sufficient to cause a temperature increase such that the SMA experiences a full or partial transition from one shape or length to another. The temperature required to cause transition is a function of the SMA being used, its dimensions and properties, and may be measured by conducting various, and in most cases customary mechanical and electrical testing on the given SMA.

In one example of SLiM, the SMA element (actuator) is composed of a Nickel-Titanium alloy or a ferrous alloy. The element is about two inches in diameter and three feet long and is made from about 80 wires, each having a diameter of about ⅛ inches. The ends of the wires are swaged into two compression fittings, which hold the wires parallel and transmit force and current to the wires. The body of the device is a pipe (a tubular housing) which transmits force and current, and which provides a fulcrum at one end, and which additionally reduces the corona emitted by the device. A lever, which pivots on the body, magnifies the length change in the SMA wires by about 5.5:1 in this example. The current required to heat the SMA wires through their transformation is passed through the wires. In this example, about one-third of the current is made to pass through the SMA element and the other two-thirds passes through the body of the device.

SmartConductor

The actuator in the SmartConductor is also made of the similar material (a shape memory alloy) as SLiM. However, the actuator is wrapped inside an aluminum or other conductive materials similar to the construction of the overhead transmission lines, e.g. ACSS (Aluminum Conductor Steel Supported) which has steel core cables wrapped by multiple layers of aluminum wires. The temperature increase on the SmartConductor actuator is primarily by direct heat transfer (conduction) from the aluminum cover which itself heats due to normal resistive heating. Temperature increase of the SmartConductor will cause its SMA core to go through partial or full transition and reduce the effective length of the SmartConductor and hence the line in the span. SmartConductor does not use any amplification system as does SLiM, but simply reduces the length of the transmission line by an amount equal to the amount of shortening of the SmartConductor. Despite the lack of amplification, the inventor has calculated that the conductor length reduction provided by SmartConductor will be adequate for many applications. Furthermore, multiple or longer Smart Conductors can be placed on power lines to increase its effect on the line. Furthermore, SmartConductor may be manufactured as a new conductor for new installations or replacing existing lines of overhead transmission lines which will let the line operate at higher temperatures and lower sags than existing conductors such as ACSR or ACSS. SmartConductor is a simpler device than SLiM (which itself is of considerably less complexity than previous systems) and may be manufactured and installed at a very cost-efficient price. SmartConductor affects a decrease in line sag during the high temperature operation that maybe transmitted through several adjacent spans, depending on construction specifics. SmartConductor is activated by the same temperature changes that cause a conductor to sag—ambient conditions and line current. The actuator (which uses Shape Memory Alloy) is thermally-affected such that its length changes as a function of line temperature and thereby compensating for sag at higher temperatures. As line temperature returns to normal, SmartConductor returns to its original length and therefore automatically resets itself. SmartConductor can be fitted in-line or between a fixed point on the tower and a power line suspended from the tower or as a complete replacement of an existing line or in a new installation. In certain embodiments, the actuator is an iron alloy or a Nickel-Titanium alloy. The amount of actuation (strain recovery) in the SmartConductor actuator is a function of the amount of length reduction it needs to provide to reduce the line sag at high temperatures. When the SmartConductor is made of a short section placed in a long power line span, it usually will require a large strain recovery to maximize its impact on the line. On the opposite end, if the SmartConductor replaces the full span or is used as a new conductor, its actuator's strain recovery has to be very small to mainly nullify the material's thermal expansion. The alloy compositions disclosed may be used with the SmartConductor device as a new or replacement conductor where high operating temperatures are desired. This is referred to as High Temperature Low Sag conductors. However, it will be clear to one of skill in the art that the alloys disclosed may be used for other applications and with other devices.

Alloy Compositions

The alloys of the invention encompass shape memory alloys that include at least the following elements: Iron, Manganese and Silicon. Additionally, Chromium, Nickel, Niobium, Cobalt, Copper, Aluminum, Nitrogen, Boron, and Carbon may be included.

The Iron content of the alloys may range from 50 to 80% wt and is generally between about 60 and 70% wt. The Manganese content may range from 10 to 35% wt and is generally between about 16 and 30% wt. The Silicon content may range from 0 to 15% wt and is generally between about 4 and 8% wt, most commonly about 6% wt. Chromium may be present from about 0 to 20% wt, generally 7 to 11% wt, most commonly about 9% wt.

Nickel may be present from about 0 to 10% wt, most commonly about 5% wt.

Niobium may be present from about 0 to 5% wt, most commonly about 1% wt.

Cobalt may be present from about 5 to 20% wt, most commonly about 10% wt.

Copper may be present from about 0 to 5% wt, most commonly about 2% wt.

Aluminum may be present from about 0 to 2% wt, most commonly about 1% wt.

Nitrogen may be present from about 0 to 1% wt, most commonly about 0.2% wt.

Boron may be present from about 0 to 1% wt, most commonly about 0.2% wt.

Carbon may be present from about 0 to 5% wt, most commonly about 0.5% wt.

In other embodiments, other elements including, but not limited to Silver, Mercury, Titanium, Tin, Germanium, Cerium, and Molybdenum may additionally be included. Typical trace elements may include vanadium, magnesium, zinc, and titanium. Various elements may be added, removed and varied to alter the physical characteristics desired, such as conductivity, Young's modulus, and shape-memory properties. Silver, Mercury, Titanium, Tin, Germanium, Cerium, and Molybdenum may be added in an amount of about 0.01 to about 1.5% wt, sometimes in an amount of about 0.1 to about 0.5% wt generally not exceeding about 2.5wt %.

Six exemplary alloy compositions are (numbers represent percent weight):

Alloy 1:64Fe-16Mn-6Si-9Cr-5Ni

Alloy 2: 64Fe-30Mn-6Si

Alloy 3: 63.8Fe-16Mn-6Si-9Cr-5Ni-0.2N

Alloy 4: 63.5Fe-30Mn-6Si-0.5C

Alloy 5:59Fe-11Mn-6Si-9Cr-5Ni-10Co

Alloy 6: 62.9Fe-16Mn-6Si-9Cr-5Ni-1Nb-0.2C

The percent weight values in all cases may vary as described above and the embodiments encompass all ranges and increments of between stated maximum and minimum quantities disclosed.

The invention encompasses alloys that may be used in various applications for the modification of line sag. Two important exemplary applications for the alloys of the invention are for use in the conductor's core and as an actuator.

The physical characteristics of the alloys of the invention are different for different applications. Table 1 shows the properties of the new SmartConductor with the new core made of ferrous shape memory alloy. In this table, equivalent properties of a commonly used conductor, ACSS (Aluminum Conductor Steel Supported) are also reported for comparison basis. Table 2 shows the target properties for the shape memory wires comprising the SmartConductor's core. Values listed in both these tables are approximates and represent a target range.

TABLE 1
Properties for the New SmartConductor and an existing Conductor

| Parameter | Unit | Value | ACSS Equiv. |
|---|---|---|---|
| Conductor Diameter | In | 1.1 ± 5% | 1.108 |
| Core Diameter | In | 0.4 ± 5% | 0.408 |
| Electrical Resistance (DC) | Ω/km | 0.07 (+2%; -no | 0.0702 |
| | | limit) | |
| Conductor total cross-sectional Area | In² | 0.72 ± 10% | 0.7264 |
| Aluminum Cross-sectional Area | In² | 0.625 ± 10% | 0.6247 |
| Core Cross-sectional Area | In² | 0.1 ± 10% | 0.1017 |
| Strand diameter - Aluminum | In | 0.1749 ± 2% | 0.1749 |
| Strand diameter - Core | In | 0.136 ± 5% | 0.1360 |
| Weight | Lbs/Ft | 1.1 ± 10% | 1.0934 |
| Conductor Breaking Strength | Kips | 30,000 ± 20% | 31,500 |
| Core Wire Coating | | None or Galfin | Galvanized/Galfan |
| Aluminum Material Specification | N/A | Al-1350 O-Temper | Al-1350 O-Temper |
| Core Material Specification | N/A | New | ASTM B-498 |
| Ultimate Strength of Core Material | Ksi | 160 ± 30% | 170-220 |
| Elongation at Break for Core | % | >5% | ˜4% |

TABLE 2
Properties for SmartConductor Core Applications

| Parameter | Units | Target Value |
|---|---|---|
| Elongation at Break | % | >5% |
| Ultimate Strength | Ksi | ˜160 (higher-better) |
| Yield Strength | Ksi | ˜100 (higher-better) |
| Wire Diameter | Inch | ˜0.136 |
| Young's Modulus (Martensitic/Austenitic) | Ksi | 15,000-35,000 (higher-better) |
| Coefficient of Thermal Expansion | in/in/° F. | Depends on recovery strain (see |
| (Martensitic/Austenitic) | | below) |
| Electrical Resistivity | nΩ-m | 500-800 |
| Corrosion Resistance | | Good to Excellent |
| Hysteresis | ° C. | <50 (smaller-better) |
| Austenite Start Temperature | ° C. | Between 80 and 100 |
| Austenite Finish Temperature | ° C. | >250 (depends on strain - see below) |
| Martensite Start Temperature | ° C. | Between 100 and 200 |
| Martensite Finish Temperature | ° C. | Between 30 and 80 |
| Transformation Strain between 90-250° C. | % | 0-0.06 |
| (also see below) | | |

*Typical for steel.
‡Galvanized coating.

The known physical characteristics of the six exemplary alloys are as follows.

64Fe-16Mn-6Si-9Cr-5Ni

Elongation at fracture: >30%

Yield Strength: 50-120 ksi (kilo pounds per square inch). Large variation arises from the grain size effect. Higher strengths are possible at grain sizes less than 10 μm

Ultimate Tensile Strength: 110-160 ksi. Large variation arises from the grain size effect.

Elastic Modulus: 18,000 ksi+10%

Martensite Start Temperature: 20-50° C.

Austenite Start Temperature: 90-120° C.

Austenite Finish Temperature: 150-400° C.

64Fe-30Mn-6Si

Elongation at fracture: >60%

Yield Strength: 40-60 ksi. Grain size effect is not known.

Ultimate Tensile Strength: 100-120 ksi. Grain size effect is not known.

Elastic Modulus: Unknown

Martensite Start Temperature: 50-70° C.

Austenite Start Temperature: 120-170° C.

Austenite Finish Temperature: Unknown

63.8Fe-16Mn-6Si-9Cr-5Ni-0.2N

Elongation at fracture: >10%

Yield Strength: 70-125 ksi. Large variation arises from the grain size effect.

Ultimate Tensile Strength: 170 ksi.

Elastic Modulus: Unknown

Martensite Start Temperature: Unknown

Austenite Start Temperature: 60-150° C.

Austenite Finish Temperature: Unknown

63.5Fe-30Mn-6Si-0.5C

Elongation at fracture: >30%

Yield Strength: >50 ksi. Grain size effect is not known.

Ultimate Tensile Strength: >100 ksi. Grain size effect is not known.

Elastic Modulus: Unknown

Martensite Start Temperature: Unknown

Austenite Start Temperature: Unknown

Austenite Finish Temperature: Unknown

59Fe-11Mn-6Si-9Cr-5Ni-10Co

Elongation at fracture: >50%

Yield Strength: 50 ksi. Grain size effect is not known.

Ultimate Tensile Strength: 130 ksi. Grain size effect is not known.

Elastic Modulus: Unknown

Martensite Start Temperature: Unknown

Austenite Start Temperature: 110° C.

Austenite Finish Temperature: Unknown

62.9Fe-16Mn-6Si-9Cr-5Ni-1Nb-0.2C

Elongation at fracture: >50%

Yield Strength: 55 ksi

Ultimate Tensile Strength: 125 ksi

Elastic Modulus: Unknown

Martensite Start Temperature: Unknown

Austenite Start Temperature: Unknown

Austenite Finish Temperature: Unknown

Phase Transformations

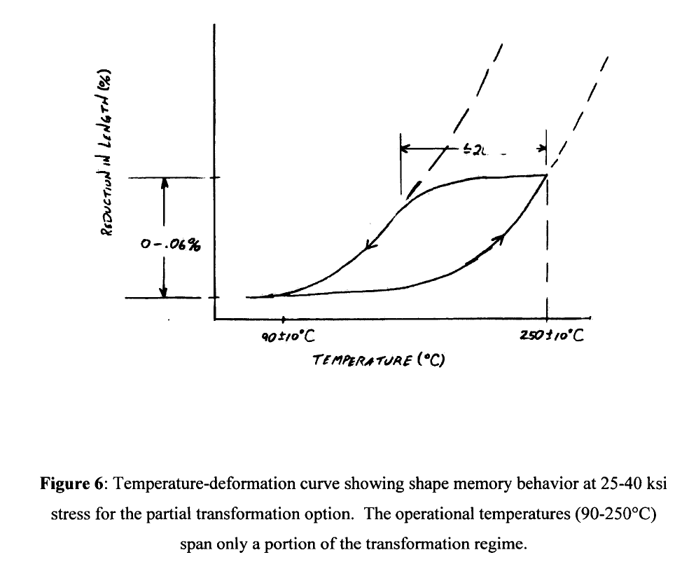

In use, shape recovery of the shape memory wires may occur under at least two different sets of conditions. In the first, the operating temperature range (90-250° C.) spans the entire transformation regime, and the entire potential transformation strain is utilized (FIG. 5). In this case, the transformation strain from the martensitic finish temperature (Mf) to the austenitic finish temperature (Af) should be between 0% and 0.06% strain. Under a second set of conditions, the operating temperature range spans only a portion of the transformation regime at its low temperature end (FIG. 6). Under these conditions, only a portion of the potential transformation strain is used and the transformation strain from Mf to the end of the operating temperature range (250° C.) is between 0% and 0.06% strain. It should be noted that the above temperature limits (90° C. and 250° C.) are only for reference purposes and can be changed for other applications to anywhere between 40° C. and 400° C.

Processing Sequence

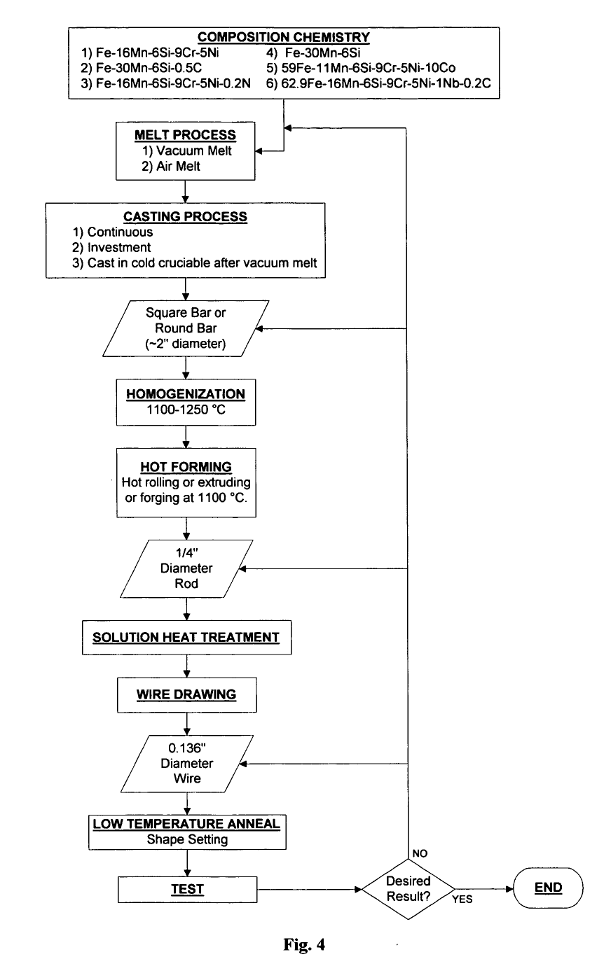

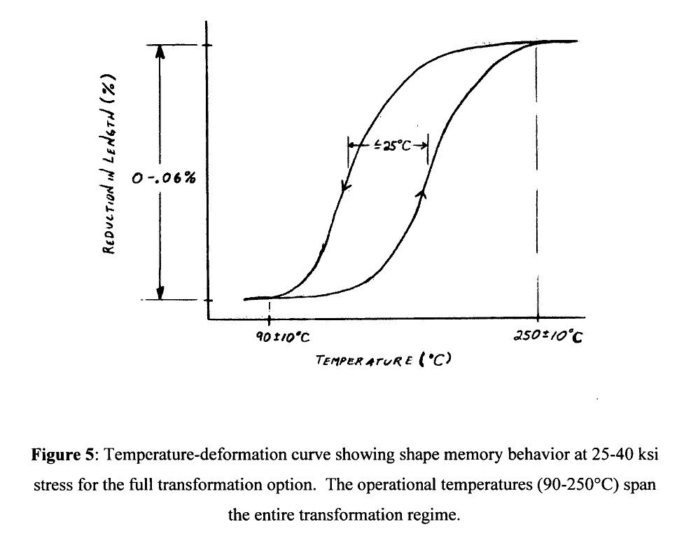

The alloys of the invention are produced using a specific processing sequence (FIG. 4). The processing sequence includes the following steps.

1. Melting. Commercially pure initial elements are mixed according to their desired weight percentages in the final alloy. The materials are melted and cast either in vacuum or in air. Air melting may introduce inclusions or “dirt” that may reduce the recovered strain, which is desirable is most embodiments.

2. Casting. Casting can be done using one of the following methods: 1) continuous casting, 2) investment casting, 3) vacuum induction skull melting, 3) arc melting and casting in cold crucibles.

3. Homogenization. Alloys #2, #4, #5 and #6 are usually homogenized after casting to improve hot-workability. Typical homogenization temperatures range from 1100° C. to 1250° C. for 15 hrs to 24 hrs. Alloys #1 and #3 are occasionally homogenized before hot-working. These alloys are homogenized if the initial hot working attempt is unsuccessful. Homogenization should be done in vacuum or argon. If the material is homogenized in air, the surface layer (oxide layer) should be removed before hot-working, otherwise it will cause cracking.

4. Hot Working. Usually hot rolling, hot extrusion or hot forging is used. Hot rolling is more common. The hot rolling temperature is 1100° C. for all alloys. Percent reduction per pass is about 5-7%. Where formability is poor, temperature may be increased. Initial round bar is generally reduced down to a diameter which can be used to draw wire (usually about 0.25″ diameter).

5. Solution Treatment. This is generally done at about 1100° C. for 1 hour in argon or in air. Argon is preferred. Then, the ingots should be water-quenched. If the ingots are solution treated in air, then the surface layer should be removed (at least 1 mm) before wire drawing.

6. Wire Drawing. Wire drawing can be done cold or hot. The reductions step in each pass depend on the drawing temperature but it can be something in between 5 to 20%. During cold drawing practice, intermediate annealing steps may be required. If that's the case, short time annealing above 500° C. should be done. The final stage of wire drawing should produce samples with 0% (fully annealed), 5%, 10% and 20% area reduction depending on the initial material and the desired strength and shape recovery levels.

Continuous Casting and Rolling Operation

A continuous casting and rolling operation capable of producing continuous rod as specified in this application is as follows:

A continuous casting machine serves as a means for solidifying the molten alloy metal to provide a cast bar that is conveyed in substantially the condition in which it solidified from the continuous casting machine to the rolling mill, which serves as a means for hot-forming the cast bar into rod or another hot-formed product in a manner which imparts substantial movement to the cast bar along a plurality of angularly disposed axes.

The continuous casting machine is of conventional casting wheel type having a casting wheel with a casting groove partially closed by an endless belt supported by the casting wheel and an idler pulley, however continuous casting machines of the twin belt type may be used provided such machines are equipped with cooling means suitable for maintaining the temperature of the cast bar within the range hereinafter set out. The casting wheel and the endless belt cooperate to provide a mold into one end of which molten metal is poured to solidify and from the other end of which the cast bar is emitted in substantially that condition in which it solidified.

The rolling mill is of conventional type having a plurality of roll stands arranged to hot-form the cast bar by a series of deformations. The continuous casting machine and the rolling mill are positioned relative to each other so that the cast bar enters the rolling mill substantially immediately after solidification and in substantially that condition in which it solidified. In this condition, the cast bar is at a hot-forming temperature within the range of temperatures for hot-forming the cast bar at the initiation of hot-forming without heating between the casting machine and the rolling mill. In the event that it is desired to closely control the hot-forming temperature of the cast bar within the conventional range of hot-forming temperatures, means for adjusting the temperature of the cast bar may be placed between the continuous casting machine and the rolling mill without departing from the inventive concept disclosed herein.

The roll stands each include a plurality of rolls which engage the cast bar. The rolls of each roll stand may be two or more in number and arranged diametrically opposite from one another or arranged at equally spaced positions about the axis of movement of the cast bar through the rolling mill. The rolls of each roll stand of the rolling mill are rotated at a predetermined speed by a power means such as one or more electric motors and the casting wheel is rotated at a speed generally determined by its operating characteristics. The rolling mill serves to hot-form the cast bar into a rod of a cross-sectional area substantially less than that of the cast bar as it enters the rolling mill.

The peripheral surfaces of the rolls adjacent roll stands in the rolling mill change in configuration; that is, the cast bar is engaged by the rolls of successive roll stands with surfaces of varying configuration, and from different directions. This varying surface engagement of the cast bar in the roll stands functions to knead or shape the metal in the cast bar in such a manner that it is worked at each roll stand and also to simultaneously reduce and change the cross-sectional area of the cast bar into that of a rod.

As each roll stand engages the cast bar, it is desirable that the cast bar be received with sufficient volume per unit for time at the roll stand for the cast bar to generally fill the space defined by the rolls of the roll stand so that the rolls will be effective to work the metal in the cast bar. However, it is also desirable that the space defined by the rolls of each roll stand not be overfilled so that the cast bar will not be forced into the gaps between the rolls. Thus, it is desirable that the rod be fed toward each roll stand at a volume per unit of time which is sufficient to fill, but not overfill, the space defined by the rolls of the roll stand.

As the cast bar is received from the continuous casting machine, it usually has one large flat surface corresponding to the surface of the endless band and inwardly tapered side surfaces corresponding to the shape of the groove in the casting wheel. As the cast bar is compressed by the rolls of the roll stands, the cast bar is deformed so that it generally takes the cross-sectional shape defined by the adjacent peripheries of the rolls of each roll stand.

It will be readily appreciated that various adaptations and modifications of the described embodiments can be configured without departing from the scope and spirit of the invention and the above description is intended to be illustrative, and not restrictive, and it is understood that the applicant claims the full scope of any claims and all equivalents.

1. For reducing sag in a suspended cable, a sag-compensating device having a first end and a second end, wherein at least one end of the device is attached to a suspended cable, the sag-compensating device comprising an actuator, wherein the actuator comprises a shape memory alloy, wherein the actuator contracts as its temperature increases, producing a pulling force on the suspended cable thereby reducing sag in the cable.

2. The sag-compensating device of claim I wherein the shape memory alloy comprises Iron, Manganese and Silicon.

3. The sag-compensating device of claim 2 wherein the Iron content is between 50% to 80% wt, the Manganese content is between 10% to 35% wt and the Silicon content is between 0% to 1 5% wt.

4. The sag-compensating device of claim 3 wherein the Iron content is between 60% and 70% wt, the Manganese content is between 16% and 30% wt and the Silicon content is between 4% and 8% wt.

5. The sag-compensating device of claim 2 further comprising Chromium.

6. The sag-compensating device of claim 5 wherein Chromium content is between 0% wt and 20% wt

7. The sag-compensating device of claim 2 further comprising Nickel.

8. The sag-compensating device of claim 7 wherein Nickel content is between 0% wt and 10% wt.

9. The sag-compensating device of claim 2 further comprising Nitrogen.

10. The sag-compensating device of claim 9 wherein Nitrogen content is between 0% wt and 1% wt.

11. The sag-compensating device of claim 2 further comprising Carbon.

12. The sag-compensating device of claim 11 wherein Carbon content is between 0% wt and 5% wt.

13. The sag-compensating device of claim 2 further comprising Niobium with a content between 0% to 5% wt.

14. The sag-compensating device of claim 2 further comprising Cobalt with a content between about 5 to 20% wt.

15. The sag-compensating device of claim 2 wherein the shape memory alloy is 69Fe-16Mn-6Si-9Cr-5Ni.

16. The sag-compensating device of claim 2 wherein the shape memory alloy is 64Fe-30Mn-6Si.

17. The sag-compensating device of claim 2 wherein the shape memory alloy is 63.8Fe-16Mn-6Si-9Cr-5Ni-0.2N.

18. The sag-compensating device of claim 2 wherein the shape memory alloy is 63.5Fe-30Mn-6Si-0.5C.

19. The sag-compensating device of claim 2 wherein the shape memory alloy is 59Fe-11Mn-6Si-9Cr-5Ni-10Co

20. The sag-compensating device of claim 2 wherein the shape memory alloy is 62.9Fe-16Mn-6Si-9Cr-5Ni-1Nb-0.2C

21. The sag-compensating device of claim 2 wherein the shape memory alloy has a martensitic start transforming temperature of between 50° C. and 200° C.

22. The sag-compensating device of claim 2 wherein the shape memory alloy has a martensitic finish transforming temperature of between 80° C. and 250° C.

23. The sag-compensating device of claim 2 wherein the shape memory alloy has a austenitic start transforming temperature of between 50° C. and 150° C.

24. The sag-compensating device of claim 2 wherein the shape memory alloy has a austentic finish transforming temperature of between 30° C. and 100° C.

25. The sag-compensating device of claim 2 wherein the shape memory alloy has a yield strength of between 80 ksi and 200 ksi.

26. The sag-compensating device of claim 2 wherein the shape memory alloy has an ultimate tensile strength of between 90 ksi and 300 ksi.

27. The sag-compensating device of claim 2 wherein the shape memory alloy has an elongation to failure of between 5% and 50%.

28. The sag-compensating device of claim 2 wherein the shape memory alloy has an elastic modulus of between 10,000 ksi and 30,000 ksi.

29. The device of claim 2 wherein the device is strung continuously within the span of a suspended cable, and wherein both the first end and the second end are connected to two different points of the same suspended cable.

30. The device of claim 2 wherein the cable is a power line that carries a current.

31. The device of claim 30 wherein at least part of the current is conducted through the device.

32. The device of claim 30 wherein at least part of the current is conducted through the actuator.

33. The device of claim 2 wherein the device further comprises a structural element disposed between the first and second end of the device, wherein the structural element is a tubular housing having a first end and a second end and wherein the tubular housing substantially surrounds the actuator, and contacts the shape memory alloy via a pivoted contact point at least one end.

34. The device of claim 2 wherein the pulling force of the actuator is magnified by at least one lever pivotally attached to the structural element.

35. The device of claim 2 wherein the device employs only a single lever.

36. The device of claim 2 wherein the tensile force of the actuator is not magnified.
